(19) United States
(12) Patent Application Publication
(10) Pub. No.: US 2025/0239664 A1
(43) Pub. Date: Jul. 24, 2025

(54) SOLUTION FOR CONTROLLING A SUPPLY OF ELECTRICAL ENERGY TO AN ELEVATOR SYSTEM FROM A BATTERY SYSTEM

(71) Applicant: KONE Corporation, Helsinki (FI)

(72) Inventors: Jussi Lähteenmäki, Helsinki (FI); Olli Pokkinen, Helsinki (FI); Liudmila Smirnova, Helsinki (FI); Juha-Matti Aitamurto, Helsinki (FI); Teppo Vuorio, Helsinki (FI); Bahman Eskandari, Helsinki (FI)

(73) Assignee: KONE Corporation, Helsinki (FI)

(21) Appl. No.: 19/172,776

(22) Filed: Apr. 8, 2025

Related U.S. Application Data
(63) Continuation of application No. PCT/FI2022/050756, filed on Nov. 16, 2022.

(51) Int. Cl. H01M 10/42; B66B 1/34; B66B 5/00; B66B 11/04; H01M 10/48

(52) U.S. Cl. CPC H01M 10/425; B66B 1/34; B66B 1/3461; B66B 5/0018; B66B 11/04; H01M 10/482; H01M 2010/4271; H01M 2010/4278; H01M 2220/20

(57) ABSTRACT

A battery system for supplying electrical energy to an elevator system is provided, the battery system including: a battery module having a number of battery cells, a battery management unit configured to obtain measurement data from at least one sensor associated to the battery system, a communication interface for communicatively connecting the battery system to the elevator system, and a power supply interface for transferring the electrical energy between the elevator system and the battery system. Also an elevator drive system, an elevator system, a computer implemented method and a computer program are provided.

### TECHNICAL FIELD

The invention concerns in general the technical field of elevator systems. More specifically, the invention relates to a provision of electrical energy to an elevator system from a battery system.

### BACKGROUND

An operation of a conveyor system, such as an elevator system, in all situations that an external power reserve, such as a battery, is connected to the conveyor system in order to supply electrical energy to the conveyor system when needed. Such a need may e.g. arise in case of a power fault in electric network arranged to supply the conveyor system in question.

On the other hand the batteries used as the external power reserve also forms a safety risk in the building the conveyor system resides. The risk level is at least partly dependent on the type of the battery in question, but, for example, lithium-ion battery (aka Li-ion battery) may face so-called thermal runaway situation possibly causing fire, explosion, jet flames and toxic emissions. If an elevator car is carrying passengers in the thermal runaway situation and e.g. stopped in the elevator shaft in a location preventing the passengers to exit from the elevator car, life of passengers may be lost in a very short period of time. Corresponding situations may be experienced with other types of batteries as well.

Due to the above described reasons the batteries associated to the conveyor systems, especially to the elevator systems, shall be in a condition that minimize of a risk of malfunctioning of the battery in its use in a context of the conveyor systems. In accordance with prior art solutions such risks are minimized by instructing a proper treatment of the batteries e.g. as regards to shipping, storing, installing, using, maintaining, and recycling the batteries. This is important as such but unfortunately does not provide information how the batteries are actually treated throughout their lifetime.

Therefore, there is room for introducing solutions enabling a monitoring of a treatment history of a battery in a predefined accuracy and taking that into account in. Therefore, there is room for introducing solutions in the area for monitoring a battery over at least part of a lifetime of the battery so as to generate information descriptive of a treatment of the battery in question and take it into account in a decision-making of utilizing of the battery for supplying electrical energy to the conveyor system when needed.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a battery system, an elevator drive system, an elevator system, a method and a computer program in relation to a supply of electrical energy to an elevator system.

The objects of the invention are reached by a battery system, an elevator drive system, an elevator system, a method and a computer program as defined by the respective independent claims.

According to a first aspect, a battery system for supplying electrical energy to an elevator system is provided, the battery system comprises:
a battery module comprising a number of battery cells for storing electrical energy,
a battery management unit configured to obtain measurement data from at least one sensor associated to the battery system, the at least one sensor is configured to measure at least one parameter descriptive of an effect of an external factor to the battery system,
a communication interface for communicatively connecting the battery system to the elevator system, and
a power supply interface for transferring the electrical energy between the elevator system and the battery system.

The battery management unit may e.g. be configured to generate a detection result by analyzing the measurement data to indicate a condition of the battery system to control of a supply of the electrical energy over the power supply interface to the elevator system. The battery management unit may be configured to perform the analyzing by comparing the measurement data to reference data. For instance, the battery management unit may be configured to enable a supply of the electrical energy from the battery cells of the battery module in response to a generation of a detection result indicative of an acceptable condition of the battery system to supply the electrical energy over the power supply interface to the elevator system.

Still further, the battery management unit may be configured to transmit the detection result over the communication interface to a control unit of the elevator system. The battery management unit may e.g. be configured to transmit the detection result in at least one of the following manner: during a handshake procedure between the battery system and the elevator system; at predefined instances of time during an operation of the elevator system.

Alternatively or in addition, the battery management unit may be configured to transmit at least part of the measurement data to a control unit of the elevator system. The battery management unit may be configured to transmit the measurement data in at least one of the following manner: during a handshake procedure between the battery system (100) and the elevator system; at predefined instances of time during an operation of the elevator system. Still further, the battery management unit may be configured to enable a supply of the electrical energy from the battery cells of the battery module in response to a receipt of an indication on an acceptable condition of the battery system to supply the electrical energy over the power supply interface to the elevator system from the control unit of the elevator system.

For example, the at least one sensor may be configured to measure at least one of the following parameters descriptive of an effect of an external factor to the battery system: acceleration, pressure, temperature, humidity.

According to a second aspect, an elevator drive system is provided, the elevator drive system comprises:
an elevator drive control unit,
a battery system according to the first aspect as defined above.

The elevator drive control unit may be configured to receive a detection result indicative of a condition of the battery system to supply electrical energy to the elevator system. For example, the elevator drive control unit may be configured to receive the detection result in at least one of the following manner: during a handshake procedure between the battery system and the elevator system; at predefined instances of time during an operation of the elevator system. The elevator drive control unit may be configured to enable a supply of the electrical energy from the battery system over the power supply interface in response to a receipt of a detection result indicative of an acceptable condition of the battery module.

Moreover, the elevator drive control unit may be configured to receive measurement data from the battery management unit of the battery system. The elevator drive control unit may also be configured to generate a detection result, by analyzing the measurement data, to indicate a condition of the battery system to supply electrical energy over the power supply interface to the elevator system. The elevator drive control unit may be configured to perform the analyzing by comparing the measurement data to reference data.

Alternatively or in addition, the elevator drive control unit may be configured to enable a supply of the electrical energy from the battery system over the power supply interface in response to that the detection result corresponds to an indication on an acceptable condition of the battery system.

Also, the elevator drive control unit may further be configured to transmit data with a remote data centre, the data being at least one of: the measurement data; the detection result; data descriptive of the battery system.

The elevator drive control unit may further be configured to, in response to a receipt of a message from the remote data centre, prevent a utilization of the battery system.

According to a third aspect, an elevator system is provided, the elevator system comprising:
an elevator device, and
an elevator drive system according to the second aspect as described above.

According to a fourth aspect, a computer implemented method for managing a supply of electrical energy to an elevator system from a battery system is provided, the method comprises:
receiving measurement data from at least one sensor associated to the battery system,
generating a detection result by analyzing the measurement data to indicate a condition of the battery system, and
controlling the supply of the electrical energy over a power supply interface to the elevator system (100) from the battery system in accordance with the detection result.

For example, the analyzing of the measurement data may be performed by comparing the measurement data to reference data.

The supply of the electrical energy from the battery system may be enabled in response to a generation of a detection result indicative of an acceptable condition of the battery system to supply the electrical energy over the power supply interface to the elevator system.

According to a fifth aspect, a computer program is provided, the computer program comprising instructions which, when the computer program is executed by a computer, cause the computer to perform the method according to the fourth aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a battery system according to an example.

FIG. 2 illustrates schematically a portion of an elevator system according to an example.

FIG. 3 illustrates schematically a controlling entity according to an example.

FIG. 4 illustrates schematically a method according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

In accordance with some aspects of the present invention a battery system is provided wherein the battery system is implemented so that it is capable of obtaining measurement data from at least one sensor and communicating with an entity of an elevator system, such as with a control unit of the elevator system. Through the communication a condition of the battery system may be determined, and further actions may be taken as is described in the forthcoming description.

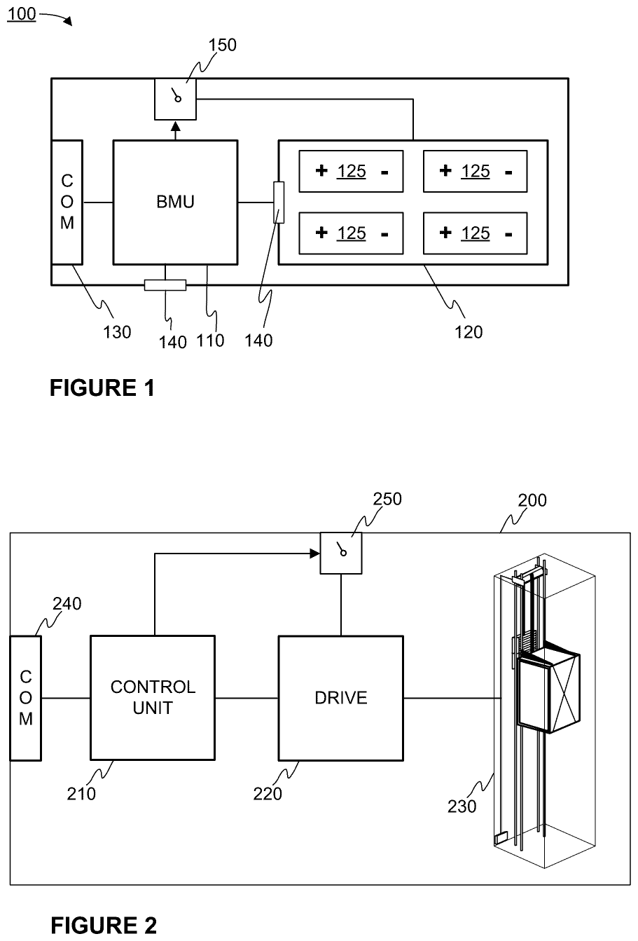

FIG. 1 illustrates schematically a battery system 100 for supplying electrical energy to an elevator system according to an example embodiment. The battery system 100 comprises a battery management unit 110 configured to manage at least some operation of the battery system 100 as is described in the forthcoming description. Further, the battery system 100 comprises a battery module 120 that comprises a number of battery cells 125, e.g. implemented with a Li-ion battery technology, for storing electrical energy in a known manner in them. The number of the battery cells 125 may be connected together so that the battery module 120 may provide the electrical energy to other entities from a common connector. The same applies with respect to charging of the battery cells 125. Still further, the battery system 100 comprises a communication interface 130 to communicatively connect the battery system 100 to an elevator system. The communication interface 130 may e.g. comprise necessary hardware and software to implement a communication technology used in the communication with the elevator system. The communication technology may be based on a wired or a wireless communication. The communication interface 130 may receive the data to be exchanged from the battery management unit 110. Moreover, the elevator system may also transmit data towards the battery system 100 in a manner as is described in the forthcoming description. Moreover, the battery system 100 may be provided with at least one sensor 140 suitable of measuring at least one predefined parameter descriptive in one manner or another of an effect of an external factor to the battery system wherein the measurement data may be obtained by the battery management unit 110. The aim with the at least one sensor 140 is to obtain data by means of which it is possible to analyze how the battery system 100 has been treated. The one or more sensors 140 may advantageously be associated to, i.e. installed at, such locations in the battery system 100 that measurement data applicable for analysis may be gathered to. Still further, the battery system 100 comprises a power supply interface 150 through which electrical energy stored in the battery cells 125 of the battery module 120 may be provided to the elevator system into which the battery system 100 is associated with. The power supply interface 150 of the battery system 200 may be controllable by the battery management unit 110 so that at least an output of the electrical energy from the battery system 100 may be controlled. The controlling may e.g. refer to enablement of the supply of the electrical energy to the elevator system, but also disabling it at least in some embodiments. For example, the interface 150 may comprise a controllable switch which may follow instructions input to the interface 150 from the battery management unit 110. In some implementations the interface 150 may be controllable from an external entity, such as from the elevator system side, and from a respective control unit therein. The power supply interface 150 may also be utilized for charging the battery cells 125 of the battery module 120.

The applied sensor(s) 140 may be selected in accordance with the parameter(s) desired to be monitored. For example, the parameters under monitoring may be at least one of the following: acceleration, vibration, pressure, temperature, and humidity. Applicable sensor type to measure at least one mentioned parameter may e.g. be an acceleration sensor, a strain gauge, a pressure sensor, a temperature sensor, and a humidity sensor. The location into which the sensor 140 is installed in the battery system 100 may be at least partly dependent on the type of sensor 140 and what is the parameter intended to be measured.

As regards to an operation of the battery system 100 the entities of the battery system 100 may be supplied with energy stored in the battery cells 125 of the battery module 120. For example, in the production phase of the battery system 100 the battery cells 120 may be charged with energy to a certain predefined level in order to enable a provision on electrical energy to the entities of the battery system 100 over a period of time the battery system 100 is not installed to the elevator system. Such charging of the battery cells 125 enables the operation of the battery system 100 and it is possible to monitor a treatment of the battery system 100 from over a lifetime of the battery, such as over the storing and transportation of the battery system 100 before it is installed to its end location to support an elevator system if needed.

The above mentioned operation of the battery system 100 to monitor the treatment of the battery system 100 may be arranged in a variety of ways in accordance with various example embodiments of the invention. In broad terms the operation of the battery system 100 in view of the present invention may be arranged either so that the battery system 100 only gathers measurement data from the one or more sensors 140 and transmits it as a raw data or as a manipulated data, such as filtered data, to another entity for analysis. Alternatively, the battery system 100, and especially the battery management unit 110, may be arranged also to analyze the gathered measurement data in a predefined manner, and take further actions in accordance with a result of the analysis. As it comes to the latter alternative it may be arranged to that the battery management unit 110 may generate a detection result by analyzing the measurement data to indicate a condition of the battery system 100 to supply electrical energy to an elevator system. The analysis may be performed in a variety of ways, but in many implementations the analyzing may be performed by comparing the measurement data to reference data. For example, the reference data may define one or more limits for the variety of measured parameters, such as maximum vibration value or a maximum allowed temperature impact, e.g. to the battery system 100, and e.g. to the battery module 120 therein, and if the measured values derived from the measurement data exceed, or deviate in any other predefined way, the reference data it may be indicated in the detection result. In the embodiment, the battery management unit 110 may be configured to transmit the detection result over the communication interface 130 to the elevator system, i.e. to a control unit of the electrically driven elevator system, upon the battery system 100 is associated, i.e. installed, to the elevator system. The transmit of the detection result may be performed e.g. when the battery system 100 is associated to the elevator system which at least comprises that a communicative connection between the battery system 100 and the elevator system is established over the communication interface 130. In accordance with an example embodiment the transmit of the detection result may be integrated to so-called handshake procedure in which the communicating parties agree a number of parameters in relation to the communication and the detection result may be transmitted in this context. This has an advantage that the detection result indicative of the condition of the battery system 100 is delivered immediately upon installation and necessary actions may be taken to prevent risk in using a battery system 100 not in a required condition. Moreover, in accordance with the present invention the analysis and/or the handshake procedure may be performed at each instant of time the battery system 100 is triggered to be coupled to the elevator system 200, e.g. when electrical energy is requested to be transferred between the elevator system and the battery system 100. On the other hand, the battery system 100 may be configured to continue the monitoring even if it is associated to the elevator system and to perform the determination of the detection result in the described manner from the measurement data. In such case, it may be arranged that the detection result is transmitted at predefined instances of time during an operation of the electrically driven elevator system, such as every instant of time the detection result is generated or when the battery system 100 is requested to be coupled to the elevator system, or at some regular intervals, e.g. once a day or anything similar. For sake of clarity, it is worthwhile to mention that even if it is improbable that the battery system 100 experiences e.g. an external shock when associated to the elevator system, it may still be effected on changes in temperature and/or in humidity and, therefore, the monitoring is continued. When associated to the elevator system the battery cells 125 may be re-charged either continuously or at intervals which then allows the operation of the battery management unit 110 to continue the monitoring operation.

As mentioned in the foregoing description the other approach may be that the measurement data, or at least part of it, or even manipulated set of the measurement data may be transmit to the elevator system, and to a control unit therein. FIG. 2 illustrates schematically an example of a portion of the elevator system 200 into which the battery system 100 may be associated to. The elevator system 200 may comprise a control unit 210 which may be configured to one or more operations of the elevator system 200. For example, the control unit 210 may be an elevator drive control unit or any other controller of the elevator system 200. In accordance with the present invention the control unit 210 may be configured to control an operation of the elevator drive system by generating control signals thereto so that the elevator drive system 220 may operate the elevator device 230 in a desired manner. In other words, the elevator device 230 may e.g. an electric motor to drive a traction sheave in order to causing movement of an elevator car in an elevator shaft. Still further, the elevator system 200 comprises a communication interface 240 configured to interact with the communication interface 130 of the battery system 100 so that data may be transferred between the entities and at least from the battery system 100 to the elevator system 200. The association of the battery system 100 with the elevator system 200 in terms of a distribution of the electrical energy from the battery system 100 to the elevator system 200 may be arranged with a power supply interface 250 of the elevator system 200. In other words, the power supply interface 150 of the battery system 100 may be connected with the power supply interface 250 of the elevator system 200. Here, the interface may e.g. refer to an arrangement implemented with suitable connectors at both end, such a plug and a socket type arrangement. The power supply interface 250 at the elevator system 200 may also be equipped with a controllable switch wherein the control may be performed from the control unit 210. It may also be arranged that the control unit 210 may control the controllable switch in the battery system 100 by generating a respective control signal to the controllable switch e.g. through the battery management unit 110 over the communication interfaces referred with 130 and 240 in FIGS. 1 and 2. Generally speaking, the aim in the controlling of at least one of the interfaces referred with 150 and 250 in FIGS. 1 and 2 is to enable a distribution of the electrical energy from the battery system 100 to the elevator system 200, and/or to disabling it, but possibly also charging of the battery cells 125 of the battery module 120 from the elevator system 200. For sake of completeness it is hereby mentioned that the supplied energy to the elevator system 200 from the battery system 100 may be converted to applicable type of current, i.e. between AC and DC currents, in one of the entities. Such an electrical circuit may e.g. be included in the elevator drive system 220 in the elevator system side.

As mentioned above the elevator system 200, and the control unit 210 therein, may receive at least part of the measurement data in some form as described from the battery system 100. The measurement data may be received from the battery management unit 110 which may obtain the measurement data from the at least one sensor 140 and transmit it to the control unit 210 of the elevator system over the communication interfaces 130, 240. Moreover, the control unit 210 may further be configured to generate a detection result in a similar way to the one in which the battery management unit 110 generates the detection result as described in the foregoing description. This may comprise, but is not limited to, an analysis of the measurement data in order to indicate a condition of the battery module 120 to supply electrical energy to the electrically driven elevator system 200. For example, the analysis is performed by comparing the measurement data to reference data as is described above.

The control unit 210 of the elevator system 200 has determined the detection result in any of the described ways, i.e. received it from the battery system 100 or derived it through the analysis based on at least part of the measurement data, and in response to it the control unit 210 may be configured to perform controlling of the supply of the electrical energy from the battery system 100 to the elevator system 200. In accordance with some example embodiments the control unit 210 may be configured to enable the supply of the electrical energy from the battery module 120 in response to that the detection result corresponds to an indication on an acceptable condition of the battery system 100. This may be arranged by controlling a controllable switch in all interfaces 150, 250 where such controllable switch is present and needs to be controlled in order to establish an electrical connection from the battery module 120 to the elevator system 200. In case, the control unit 210 is also arranged to control the interface 150 of the battery system 100 the control unit 210 may be configured to generate an indication on the acceptable condition of the battery system 100 to supply the electrical energy to the electrically driven elevator system 200 and deliver it to the battery management unit 110 which then take necessary actions in accordance with the indication. In case the indication is positive, i.e. indicates that the condition of the battery module 120 is acceptable, the battery management unit 110 triggers the controllable switch 150 to a conductive state.

In a further example embodiment it may be arranged that both the battery management unit 110 and the control unit 110 of the elevator system 200 are configured to perform independent analyses to the measurement data and to control the respective interfaces 150, 250 independently from each other. In this kind of approach the battery system 100 delivers the measurement data to the control unit 210 of the elevator system 200. Now, both controlling entities are configured to independently perform the analysis and control their respective interfaces 150, 250 dedicated to the supply of the electrical energy. This kind of approach leads to a more secure system in which the measurement data is double checked. This also enables following existing guidelines in relation to an acceptance of the condition of the battery module 120 in a better way. This is because those guidelines may be updated during a period of time the battery system 100 is residing in a warehouse waiting for its installation and, therefore, rules applied in the analysis may be not updated at the battery system 100 side. Contrary to this, the rules applied in the analysis may be updated in accordance with the updated guidelines at the elevator system 200 side and, therefore, it may occur that the control unit 210 of the elevator system 200 may decide that the battery module 120 is not in an acceptable condition even if the battery management unit 110 has judged otherwise when applying old guidelines. As a result, the battery module 120 does not end up connected to the elevator system 200. Naturally, it is possible that a contrary situation occurs if the guidelines are simplified or eased.

For sake of clarity it may be mentioned that the condition of the battery system 100, and especially the condition of the battery module 120, shall be understood descriptive on that if the battery system 100 is safe to be taken into use in association to the elevator system 200 or not under the criterion/criteria defined for it. As is clear from the description herein if it is defined that the battery system 100, and especially the battery module 120, has experienced external factor(s), based on the analysis of the measurement data, its condition may be decided to be unacceptable and necessary measures may be initiated as described.

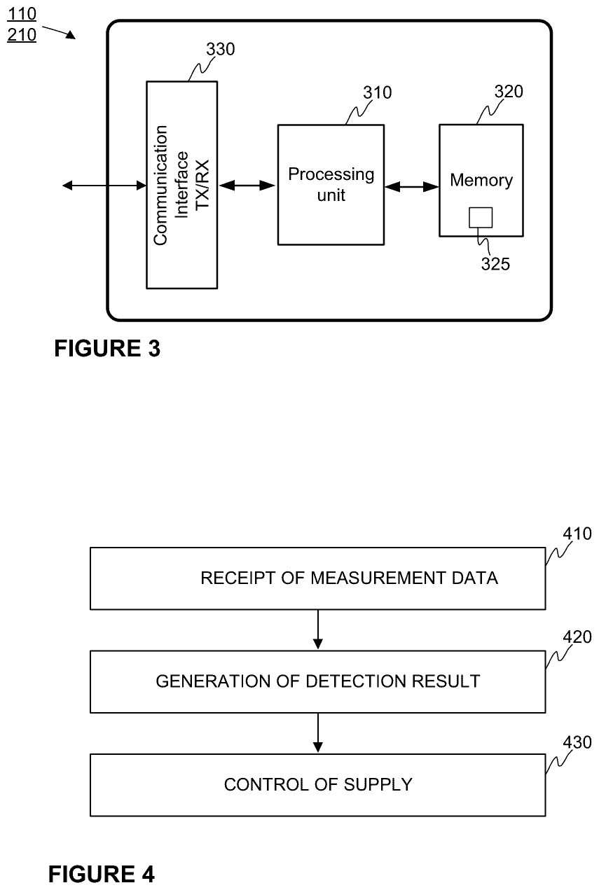

As already mentioned, both entities, i.e. the battery system 100 and the elevator system 200 comprises controlling entities, i.e. the battery management unit 110 and the control unit 210. The respective entities are configured to control operation to evaluate the treatment of the battery system 100 over the monitoring period. A non-limiting example of such a controlling entity is schematically illustrated in FIG. 3. The apparatus configurable to operate as the controlling entity comprises a processor 310 and a memory 320. The memory 320 may store data, such as pieces of data as described, but also computer program code 325 causing the operation in the described manner. The apparatus may further comprise a communication interface 330, such as a wireless communication interface or a communication interface for wired communication, or both to communicate with other entities as described. The communication interface 330 may thus comprise one or more modems, antennas, and any other hardware and software for enabling an execution of the communication e.g. under control of the processor 310. In some embodiments, the communication interface 330 may correspond to the previously described communication interfaces cited with 130 and 240 in FIGS. 1 and 2.

Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 320 and at least a portion of the computer program code 325 stored therein may further be arranged, with the processor 310, to cause the apparatus to perform at least a portion of the operation as is described herein. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some, or all of which may be integrated/removable and/or may provide permanent/semi-permanent/dynamic/cached storage.

The computer program code 325 may comprise computer-executable instructions that implement functions that correspond to steps implemented in the method as is more specifically described in the forthcoming description when loaded into the processor 310 of the respective control entity 110, 210. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform as described. Hence, the apparatus may comprise at least one processor 310 and at least one memory 320 including the computer program code 325 for one or more programs, the at least one memory 320 and the computer program code 325 configured to, with the at least one processor 310, cause the apparatus implementing the control entity 110, 210 to perform as described.

The computer program code 325 may be provided e.g. a computer program product comprising at least one computer-readable non-transitory medium having the computer program code 325 stored thereon, which computer program code 325, when executed by the processor 310, causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the operation in the manner as described in the description herein.

Any of the programmed functions mentioned may also be performed in firmware or hardware adapted to or programmed to perform the necessary tasks.

For sake of completeness it is worthwhile to mention that the entity configured to perform the method in the role of the controlling entity 110, 210 may also be implemented with a plurality of apparatuses, such as the one schematically illustrated in FIG. 3, as a distributed computing environment corresponding to a controlling entity in question. For example, one of the apparatuses may be communicatively connected with the other apparatuses, and e.g. share the data of the operation, to cause another apparatus to perform at least one other portion of the operation. As a result, the operation performed in the distributed computing environment generates the control signal indicative of the assignment of the responsibility as described. For example, some steps of the operation may be shared between the battery management unit 110 and a control unit 210 of the elevator system 200, for example.

For sake of completeness, it is worthwhile to mention that the described entities, i.e. the battery system 100 and the elevator system 200, may be arranged to transmit data to an external entity. The external entity may e.g. be a remotely locating data centre, which may be implemented as a standalone system or as a cloud computing system, or as any combination of these. In an advantageous embodiment the data is transmitted by the elevator drive control unit 210 since it is connected to the data centre in an easy way by using communication connections established to the elevator system 200. Thus, the elevator drive control unit 210 may be configured to transmit data with the remote data centre, wherein the data may be at least one of: the measurement data; the detection result; data descriptive of the battery system 100. The data descriptive of the battery system 100 may be any data obtained from the battery system 100 e.g. upon coupling it to the elevator system 200. Such data may e.g. be identification data, such as a serial number, or data relating to a manufacturing process of the battery system 100, such as an instant of time of manufacturing, or it may also define nominal values of the battery system 100. These pieces of the data may be analyzed in the data centre, e.g. by comparing them with reference data, and if a mismatch is found the data centre may transmit a control message towards the elevator system 100, and the controlling entity therein. The control signal may be a message comprising data descriptive of preventing a utilization of the battery system 100. In other words, the elevator drive control unit 210 may e.g. be configured to interpret the data in the message and in case the data requests preventing the use of the battery system 100, the control unit 210 initiates such operations, e.g. by controlling the power supply interface(s) 150, 250, respectively.

Some further aspects of the invention may relate to a computer implemented method for managing a supply of electrical energy to an elevator system 200 from a battery system 100. An example of such a method is schematically illustrated in FIG. 4. The method comprises that measurement data is received 410 from at least one sensor 140 associated to the battery system 100. In response to the receipt of the measurement data a detection result is generated 420 by analyzing the measurement data to indicate a condition of the battery system 100. Moreover, the supply of the electrical energy is controlled 430 over a power supply interface 150 to the elevator system 100 from the battery system 100 in accordance with the detection result of the analysis. For example, the analyzing of the measurement data may be performed by comparing the measurement data to reference data. According to an embodiment, the supply of the electrical energy from the battery system 100 may be enabled in response to a generation of a detection result indicative of an acceptable condition of the battery system 100 to supply the electrical energy over the power supply interface 150 to the elevator system 100. The enabling of the supply may e.g. be arranged so that the computer implementing the method generates a control signal to one or more entities, such as to at least one power supply interface 150, to enable the supply of the electrical energy. In accordance with some example embodiments, the detection result may be transmitted from the computer to other entities. E.g. if the computer implementing the method is associated to the battery system 100 it may be configured to transmit the detection result over the communication interface 130 to a control unit of the elevator system 200. Naturally, in case the computer resides in the elevator system 200 side, the detection result may be transmitted to the battery system 100. If the computer is external to both mentioned entities, the computer may be configured to transmit the detection result to both the battery system 100 and the elevator system 200. In accordance with the invention the method implemented by the respective entity may be implemented so that the detection result is transmitted in at least one of the following manner: during a handshake procedure between the battery system 100 and the elevator system 200; at predefined instances of time during an operation of the elevator system 200. Alternatively or in addition, the computer may receive at least part of the measurement data of the battery system 100 generated by at least one sensor 140 associated to the battery system 100. The measurement data may e.g. be received either during a handshake procedure between the battery system 100 and the elevator system 200; at predefined instances of time during an operation of the elevator system 200. Such an embodiment refers to an implementation in which the computer resides in the elevator system 200 side. The computer may analyse the measurement data and generate an indication, e.g. with a control signal, at least to the battery system 100 to indicate if the supply of electrical energy is allowed or not. The method may also comprise further steps as described and derivable from the foregoing description relating to the battery system 100 and the elevator drive system as well as the elevator system 200. As already mentioned, depending on an implementation the computer implementing the method as described may reside in the battery system 100 or in the elevator system 200, such as in an elevator drive system of the elevator system 100, and may refer to a control unit of the respective entity, such as a battery management unit 110 or the control unit 210. In some further implementations the computer may ever be external to the mentioned entities and refer to a computing entity accessible over a communication connection, such as a server residing in a communication network e.g. as a representative of a data centre. The server may be implemented as a standalone device or as a distributed computing environment, for example.

Advantages of the present invention are numerous. Generally speaking, the invention allows a lifetime monitoring of the battery system and controlling its use in accordance with events experienced by the battery system. This improves a safety in general and it is very important with respect to elevator systems, since they carry passengers who may get stuck in the elevator car in an event the battery system is malfunctioning.

The specific examples provided in the description given above should not be construed as limiting the applicability and/or the interpretation of the appended claims. Lists and groups of examples provided in the description given above are not exhaustive unless otherwise explicitly stated.

1. A battery system for supplying electrical energy to an elevator system, the battery system comprising:
a battery module comprising a number of battery cells for storing electrical energy,
a battery management unit configured to obtain measurement data from at least one sensor associated to the battery system, the at least one sensor is configured to measure at least one parameter descriptive of an effect of an external factor to the battery system,
a communication interface for communicatively connecting the battery system to the elevator system, and
a power supply interface for transferring the electrical energy between the elevator system and the battery system.

2. The battery system according to the claim 1, wherein the battery management unit is configured to generate a detection result by analyzing the measurement data to indicate a condition of the battery system to control of a supply of the electrical energy over the power supply interface to the elevator system.

3. The battery system according to the claim 2, wherein the battery management unit is configured to perform the analyzing by comparing the measurement data to reference data.

4. The battery system according to claim 2, wherein the battery management unit is configured to enable a supply of the electrical energy from the battery cells of the battery module in response to a generation of a detection result indicative of an acceptable condition of the battery system to supply the electrical energy over the power supply interface to the elevator system.

5. The battery system according to claim 2, wherein the battery management unit is configured to transmit the detection result over the communication interface to a control unit of the elevator system.

6. The battery system according to the claim 5, wherein the battery management unit is configured to transmit the detection result in at least one of the following manner: during a handshake procedure between the battery system and the elevator system; at predefined instances of time during an operation of the elevator system.

7. The battery system according to the claim 1, wherein the battery management unit is configured to transmit at least part of the measurement data to a control unit of the elevator system.

8. The battery system according to the claim 7, wherein the battery management unit is configured to transmit the measurement data in at least one of the following manner: during a handshake procedure between the battery system and the elevator system; at predefined instances of time during an operation of the elevator system.

9. The battery system according to the claim 8, wherein the battery management unit is configured to enable a supply of the electrical energy from the battery cells of the battery module in response to a receipt of an indication on an acceptable condition of the battery system to supply the electrical energy over the power supply interface to the elevator system from the control unit of the elevator system.

10. The battery system according to claim 1, wherein the at least one sensor is configured to measure at least one of the following parameters descriptive of an effect of an external factor to the battery system: acceleration, pressure, temperature, humidity.

11. An elevator drive system, comprising:
an elevator drive control unit,
a battery system according to claim 1.

12. The elevator drive system according to the claim 11, wherein the elevator drive control unit is configured to receive a detection result indicative of a condition of the battery system to supply electrical energy to the elevator system.

13. The elevator drive system according to the claim 12, wherein the elevator drive control unit is configured to receive the detection result in at least one of the following manner: during a handshake procedure between the battery system and the elevator system; at predefined instances of time during an operation of the elevator system.

14. The elevator drive system according to the claim 12, wherein the elevator drive control unit is configured to enable a supply of the electrical energy from the battery system over the power supply interface in response to a receipt of a detection result indicative of an acceptable condition of the battery module.

15. The elevator drive system according to the claim 11, wherein the elevator drive control unit is configured to receive measurement data from the battery management unit of the battery system.

16. The elevator drive system according to the claim 15, wherein the elevator drive control unit is configured to generate a detection result, by analyzing the measurement data, to indicate a condition of the battery system to supply electrical energy over the power supply interface to the elevator system.

17. The elevator drive system according to the claim 16, wherein the elevator drive control unit, is configured to perform the analyzing by comparing the measurement data to reference data.

18. The elevator drive system according to the claim 13, wherein the elevator drive control unit is configured to enable a supply of the electrical energy from the battery system over the power supply interface in response to that the detection result corresponds to an indication on an acceptable condition of the battery system.

19. The elevator drive system according to claim 11, wherein the elevator drive control unit is further configured to transmit data with a remote data centre, the data being at least one of: the measurement data; the detection result; data descriptive of the battery system.

20. The elevator drive system according to claim 11, wherein the elevator drive control unit is further configured to, in response to a receipt of a message from the remote data centre, prevent a utilization of the battery system.

21. An elevator system, comprising:
an elevator device, and
an elevator drive system according to claim 11.

22. A computer implemented method for managing a supply of electrical energy to an elevator system from a battery system, the method comprising:
receiving measurement data from at least one sensor associated to the battery system, generating a detection result by analyzing the measurement data to indicate a condition of the battery system, and
controlling the supply of the electrical energy over a power supply interface to the elevator system from the battery system in accordance with the detection result.

23. The method according to claim 22, wherein the analyzing of the measurement data is performed by comparing the measurement data to reference data.

24. The method according to claim 22, wherein the supply of the electrical energy from the battery system is enabled in response to a generation of a detection result indicative of an acceptable condition of the battery system to supply the electrical energy over the power supply interface to the elevator system.

25. A non-transitory computer readable medium storing a computer program comprising instructions which, when the computer program is executed by a computer, cause the computer to perform the method according t claim 22.
